(19) United States
(12) Patent Application Publication
(10) Pub. No.: US 2024/0383125 A1
(43) Pub. Date: Nov. 21, 2024

(54) ROBOT

(71) Applicant: Panasonic Intellectual Property Management Co., Ltd., Kadoma-shi (JP)

(72) Inventors: Tatsuo SAKAI, Osaka (JP); Masahiro YAMADA, Osaka (JP); Yoshiki MATSUMOTO, Osaka (JP); Shinya SATOMI, Osaka (JP); Koki OBONAI, Osaka (JP)

(21) Appl. No.: 18/663,813

(22) Filed: May 14, 2024

(30) Foreign Application Priority Data
May 15, 2023 (JP) 2023-080405

(51) Int. Cl. B25J 5/00; B25J 13/08

(52) U.S. Cl. CPC B25J 5/007; B25J 13/086

(57) ABSTRACT

Provided is a robot including: a main body that includes a base and a top plate; and a cart that is coupleable to the main body. The main body includes a detector, which detects an object that exists around the robot, in a space provided between the base and the top plate, and a body-side support that couples the base to the top plate is included in a detection range of the detector.

### TECHNICAL FIELD

The present disclosure relates to a robot.

### BACKGROUND ART

In the related art, there is known a robot including a travelable main body and a cart with wheels. The cart is coupleable to the main body. In a state in which the main body and the cart are coupled to each other (hereinafter, this state will be referred to as “coupling state”), the main body is capable of towing the cart.

For example, Japanese Patent Application Laid-Open No. 2020-111160 discloses a carriage that detects an obstacle by using a distance measurement apparatus provided in a traveling apparatus.

The distance measurement apparatus is, however, disposed on the upper surface of the traveling apparatus. Accordingly, a problem therewith is that safety decreases as the distance measurement apparatus may possibly interfere with an object present in the surrounding environment during traveling.

It is disclosed in the related art of Japanese Patent Application Laid-Open No. 2020-111160 that the distance measurement apparatus is disposed in a region between the bottom surface and the upper surface of the traveling apparatus, but the obstacle detection capability decreases by merely disposing the distance measurement apparatus in such a region.

An object of the present disclosure is to solve the above-described problems and to provide a robot that prevents, while suppressing a decrease in the obstacle detection capability, a detector from interfering with an object present in the surrounding environment during traveling and improves safety.

In order to solve the above-described problems, an aspect of a robot according to the present disclosure includes: a main body that includes a base and a top plate; and a cart that is coupleable to the main body. The main body includes a detector, which detects an object that exists around the robot, in a space provided between the base and the top plate, and a body-side support that couples the base to the top plate is included in a detection range of the detector.

According to the present disclosure, it is possible to prevent, while suppressing a decrease in the obstacle detection capability, a detector from interfering with an object present in the surrounding environment during traveling and to improve safety.

### BRIEF DESCRIPTION OF DRAWINGS

FIG. 1 is a perspective view of a robot in the present embodiment;

FIG. 2 is a perspective view illustrating a state in which a main body and a cart in the robot in the present embodiment are separated from each other;

FIG. 3 is a perspective view of the main body in the robot in the present embodiment;

FIG. 4 is a cross-sectional view of the main body in the robot in the present embodiment, when taken along a vertical plane passing through supports;

FIG. 5 is a side view illustrating a state in which the main body and the cart in the robot in the present embodiment are coupled to each other; and

FIG. 6 is a cross-sectional view of the robot in the present embodiment in a state in which the main body and the cart are coupled to each other, when taken along a horizontal plane passing through a detector.

### DESCRIPTION OF EMBODIMENTS

Hereinafter, an embodiment of the present disclosure will be described with reference to the accompanying drawings. Note that, any of the embodiment described below illustrates a specific example of the present disclosure. Accordingly, the constituent elements, the arrangement and connection of the constituent elements, and the like, illustrated in the embodiment below are mere examples, and are not intended to limit the present disclosure. Accordingly, among the constituent elements described in the embodiment below, constituent elements not recited in the independent claim will be described as optional constituent elements.

Further, the drawings are schematic diagrams and are not necessarily precise illustrations. Note that, in the drawings, substantially the same configurations are denoted by the same reference signs, and redundant descriptions will be omitted or simplified.

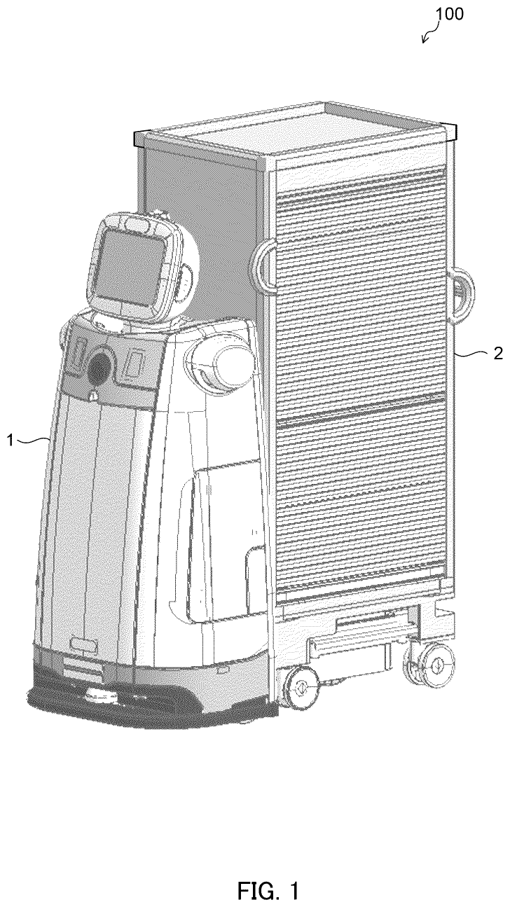

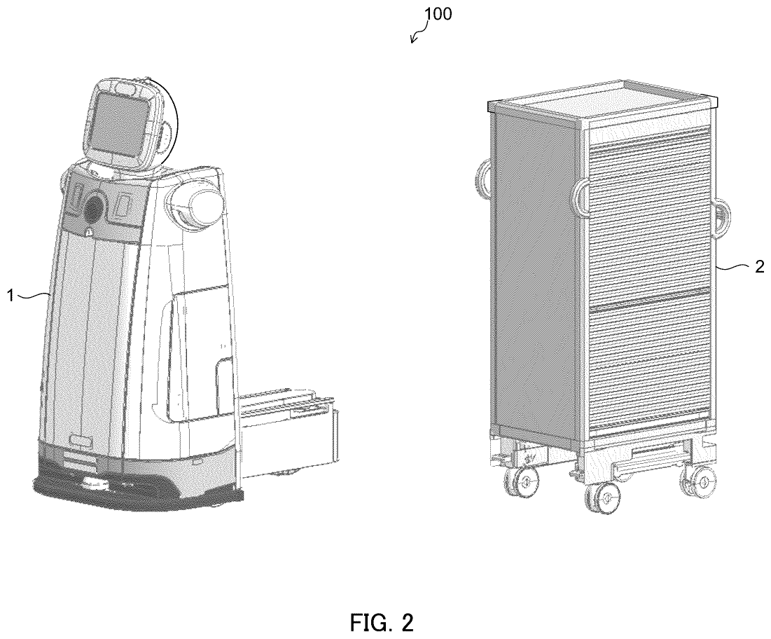

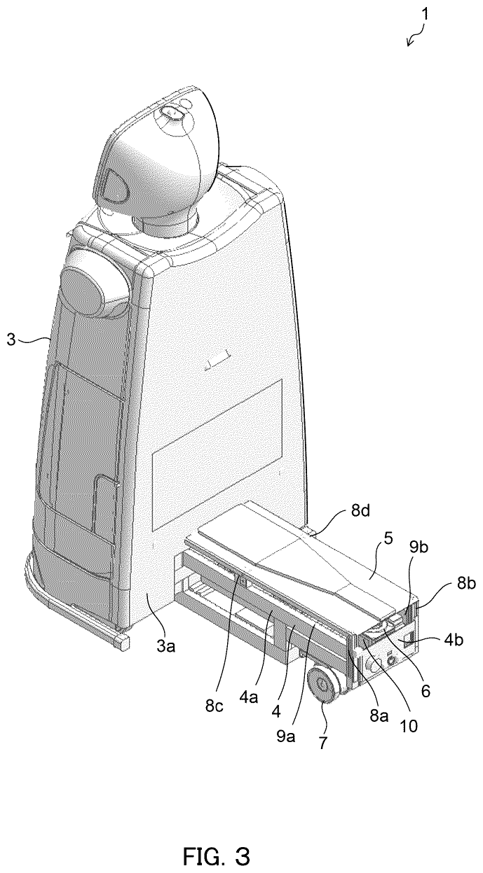

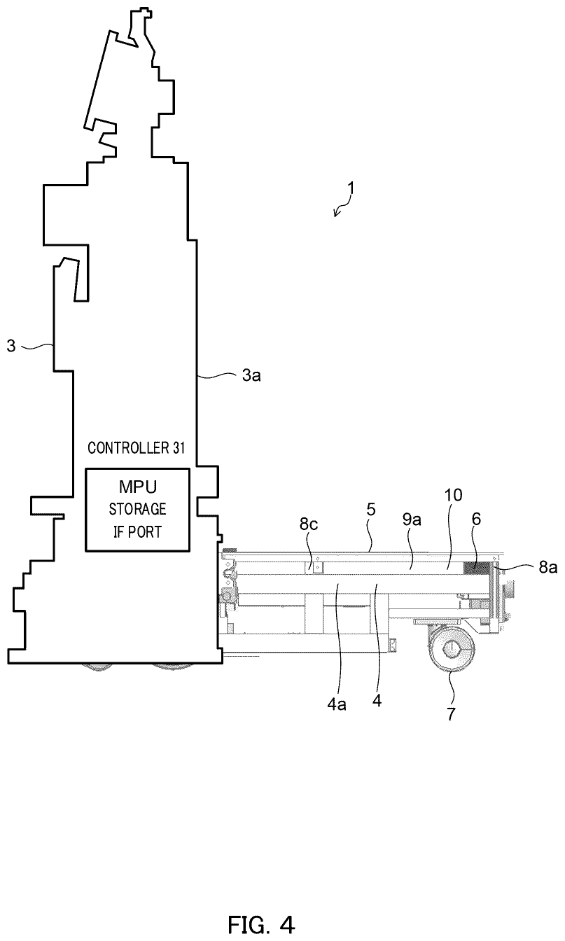

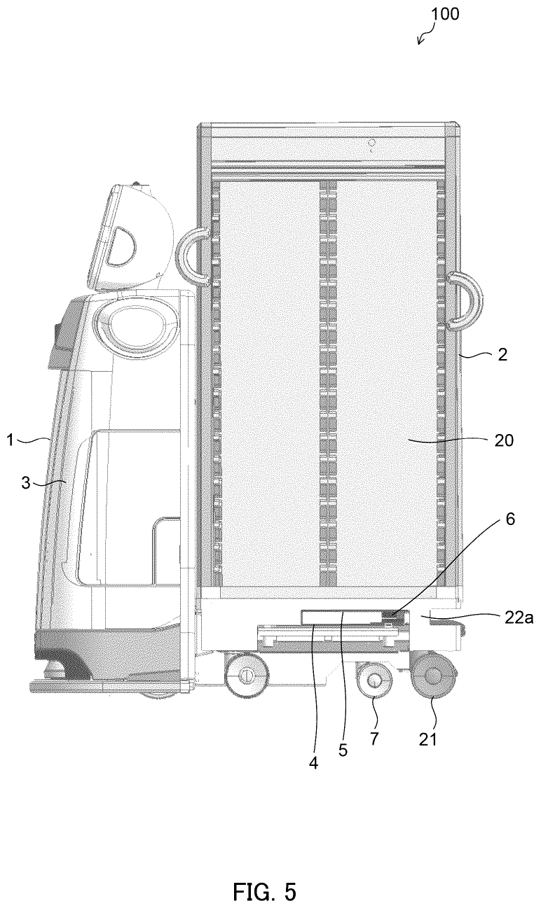

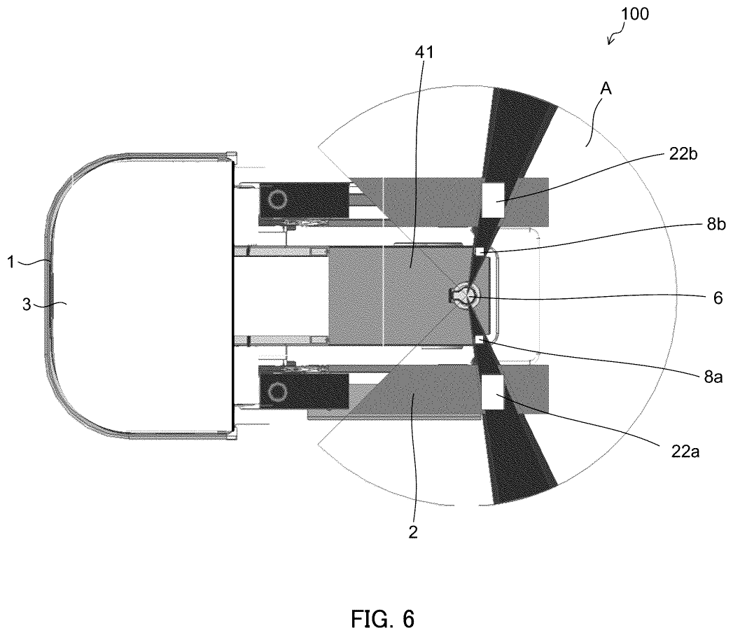

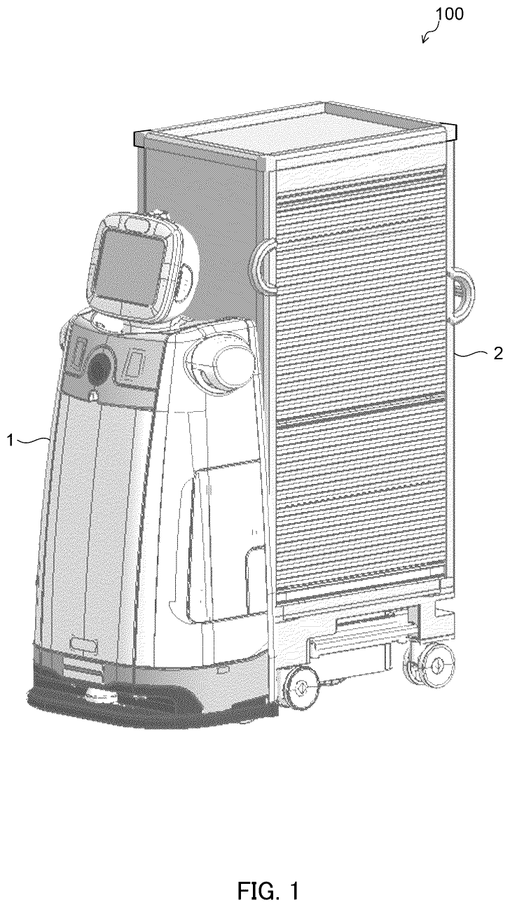

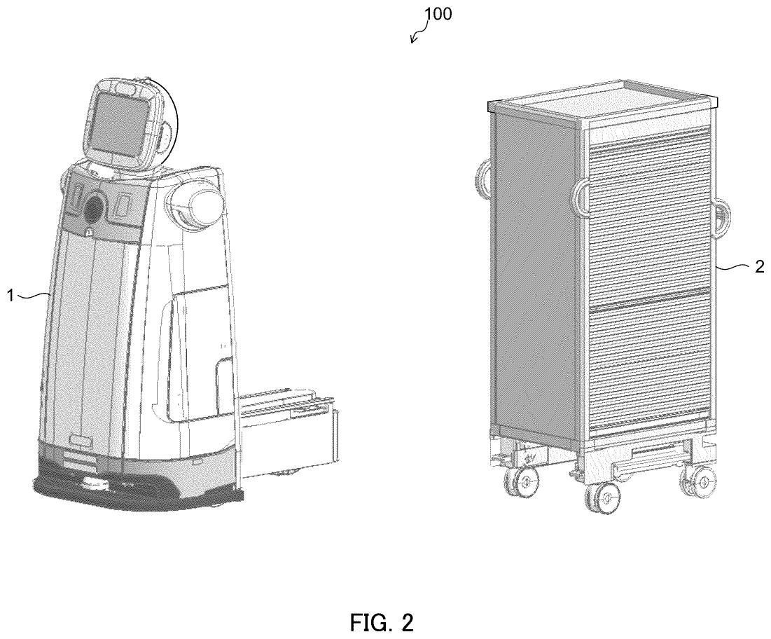

FIG. 1 is a perspective view of robot 100 in the present embodiment. FIG. 2 is a perspective view illustrating a state in which main body 1 and cart 2 in robot 100 in the present embodiment are separated from each other.

Robot 100 includes main body 1 and cart 2. Robot 100 is, for example, self-propelled in a hospital and delivers medicine from a hospital pharmacy to one or a plurality of destinations at a time. Robot 100 may be configured to be travelable by remote control, for example.

Main body 1 delivers medicine loaded in cart 2 at one time and is self-propelled from the hospital pharmacy to a destination. Main body 1 stops when main body 1 arrives at the destination.

Then, when main body 1 arrives at an arbitrarily set destination, the coupling state between main body 1 and cart 2 is automatically released. Further, here, a nurse may pull cart 2 from main body 1 to decouple main body 1 from cart 2.

Then, the nurse performs medication administration and returns cart 2 to the hospital pharmacy. Alternatively, cart 2 may be conveyed to the hospital pharmacy by robot 100, which has towed cart 2, or another robot 100.

Main body 1 decoupled from the cart, on the other hand, is self-propelled and returns to the hospital pharmacy by itself. Then, a hospital pharmacist loads another cart 2 with medicine and couples this cart 2 to main body 1. The coupling state between main body 1 and cart 2 is maintained by a locking mechanism (not illustrated). Hereinafter, the specific configuration of robot 100 will be described.

Hereinafter, robot 100 that is self-propelled in a hospital will be described as an aspect of a contemplated embodiment, but the present disclosure is not limited thereto and is widely applicable to robots that perform delivery both in and outside facilities.

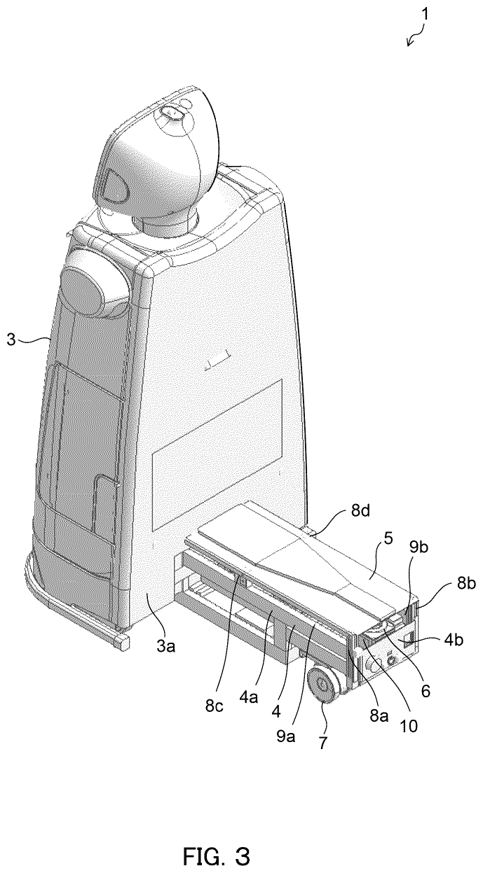

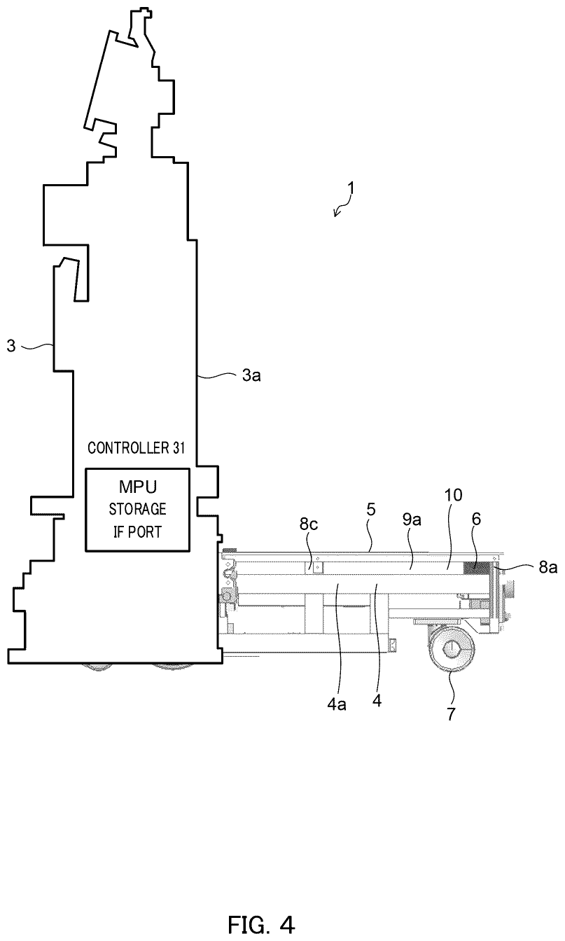

First, the outline of robot 100 will be described. FIG. 3 is a perspective view of main body 1 in robot 100 in the present embodiment. FIG. 4 is a cross-sectional view of main body 1 in robot 100 in the present embodiment, when taken along a vertical plane passing through supports 8a and 8c. Note that, the cross-section of body 3 in robot 100 is omitted in the cross-sectional view illustrated in FIG. 4.

Main body 1 is a moving body configured in a travelable manner. Main body 1 includes body 3, base 4, top plate 5, detector 6, wheels 7, and supports 8a to 8d.

Body 3 includes controller 31. Controller 31 is formed of a micro processing unit (MPU), a storage, an interface (IF) port, and the like. Controller 31 performs integrated control of the operation of main body 1.

Base 4 is fixed to a lower portion of rear surface 3a of body 3. Base 4 has a substantially rectangular parallelepiped shape, and includes, in a rear lower portion of base 4, two wheels 7 facing each other in the width direction of main body 1. Note that, FIGS. 3 and 4 illustrate only one of wheels 7. Top plate 5 has a rectangular plate shape and is disposed above base 4.

As illustrated in FIGS. 3 and 4, top plate 5 is fixed to base 4 via supports 8a to 8d. Support 8a and 8b are vertically formed on sides of the rear surfaces of two corner portions of top plate 5 at the rear end of top plate 5, and are fixed to the upper surfaces of two corner portions of base 4 at the rear end of base 4.

Further, in positions between rear surface 3a of body 3 and the rear end of top plate 5, supports 8c and 8d are vertically formed on sides of the rear surfaces of two end portions of top plate 5 in the width direction of main body 1, and are fixed to the upper surfaces of two end portions of base 4.

Main body 1 includes space 9a between both side surfaces 4a of base 4 and top plate 5, and includes space 9b between rear surface 4b of base 4 and top plate 5. That is, support 8a and 8b that couple base 4 to top plate 5 are provided in two corner portions of the rear end of main body 1, and spaces 9a and 9b are formed on both sides of support 8a and 8b.

Laser light emitted from detector 6 pass through spaces 9a and 9b. By providing such spaces 9a and 9b, it is possible to suppress a decrease in the obstacle detection capability.

Detector 6 is, for example, a light detection and ranging (LiDAR) apparatus, and at least scans a plane horizontal to the traveling surface to perform obstacle detection. Note that, detector 6 is not limited to the LiDAR apparatus, but may be another sensor or the like.

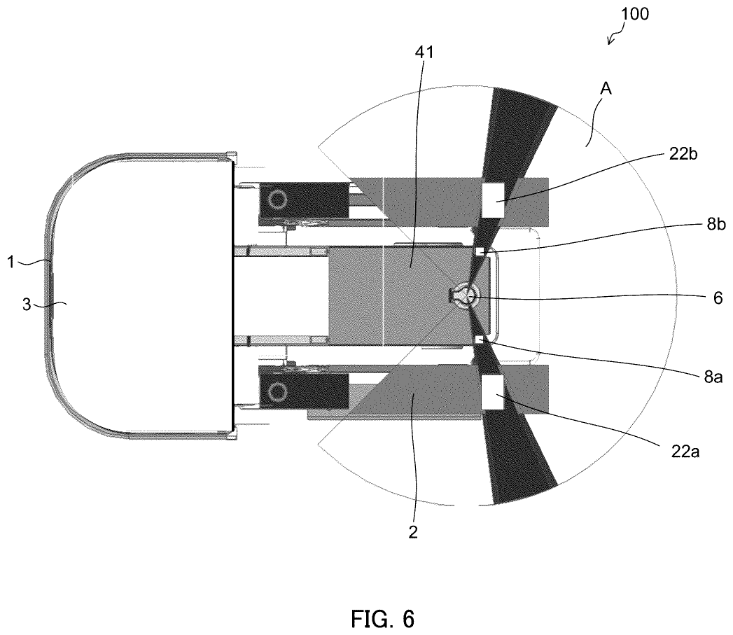

Detector 6 is disposed on a side of the upper surface of flat plate 41 (see FIG. 6) of base 4. By disposing detector 6 in space 10 provided between base 4 and top plate 5, it is possible to prevent detector 6 from interfering with an object present in the surrounding environment during traveling and to improve safety.

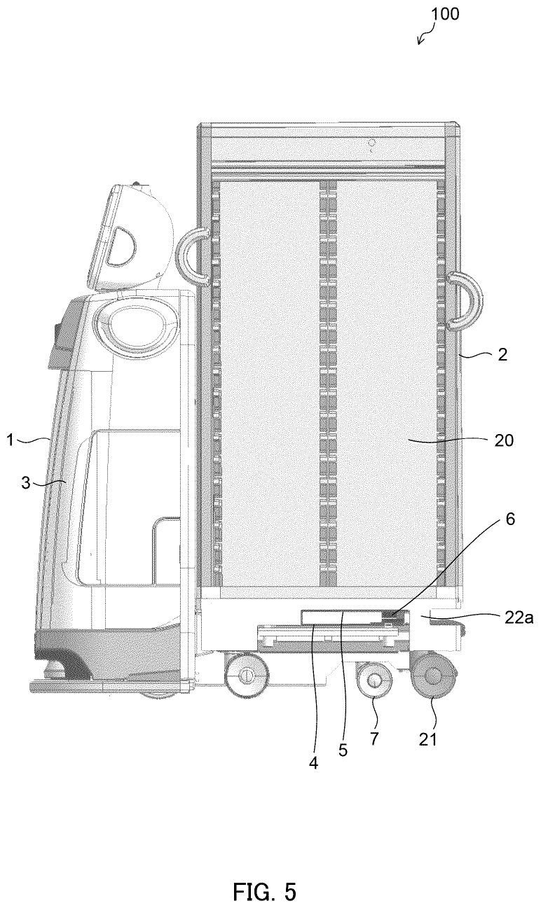

FIG. 5 is a side view illustrating a state in which main body 1 and cart 2 in robot 100 in the present embodiment are coupled to each other. FIG. 6 is a cross-sectional view of robot 100 in the present embodiment in a state in which main body 1 and cart 2 are coupled to each other, when taken along a horizontal plane passing through detector 6.

As illustrated in FIG. 5, in the coupling state between main body 1 and cart 2, detector 6 is located below cart 2. By disposing detector 6 in this manner, it is possible to achieve reduction in the size of robot 100.

As illustrated in FIGS. 5 and 6, cart 2 includes storer 20, wheels 21, and supports 22a and 22b.

Storer 20 has a substantially rectangular parallelepiped shape, and stores a thing such as medicine. Storer 20 includes, in a rear lower portion of storer 20, two wheels 21 facing each other in the width direction of storer 20. Storer 20 is coupled to wheels 21 via supports 22a and 22b.

Note that, FIG. 5 illustrates a state in which a door of storer 20 is open, and further FIG. 5 illustrates only one of wheels 21.

In addition, as illustrated in FIG. 6, on scan surface A of detector 6 when main body 1 and cart 2 are coupled to each other, support 8a on the side of main body 1, detector 6, and support 22a on the side of cart 2 are arranged in series, and support 8b on the side of main body 1, detector 6, and support 22b on the side of cart 2 are arranged in series in the same manner. Supports 8a and 8b that couple base 4 to top plate 5 are included in a detection range of detector 6.

By arranging those described above in series, it is possible to minimize the range in which detector 6 cannot detect any obstacle, and it is possible to improve the obstacle detection capability.

Although scan surface A of detector 6 illustrated in FIG. 6 is a horizontal plane here, this scan surface A may not be a horizontal plane.

Note that, the present disclosure is not limited to the embodiment described above, and can be changed as appropriate without departing from the spirit thereof.

For example, it is configured in the embodiment described above that support 8b on the side of main body 1, detector 6, and support 22b on the side of cart 2 are arranged in series, but what is to be arranged in series with support 8b on the side of main body 1 and detector 6 is not limited to support 22b on the side of cart 2, but may be any other configuration on the side of cart 2.

Even in such a case, it is possible to minimize the range in which detector 6 cannot detect any obstacle, and it is possible to improve the obstacle detection capability in the same manner as in the embodiment described above.

Further, it is configured in the embodiment described above that support 8b on the side of main body 1, detector 6, and support 22b on the side of cart 2 are arranged in series.

As another configuration, there is also a configuration in which on scan surface A of detector 6, a cart to be coupled to main body 1 in robot 100 includes no structure behind a rear end portion of a side surface of the cart.

In the case of such a cart, on scan surface A of detector 6 when main body 1 and the cart are coupled to each other, a support on the side of main body 1, detector 6, and the rear end portion of the side surface of the cart may be arranged in series. Scan surface A of detector 6 may or may not be a horizontal plane.

By arranging those described above in series, it is possible to minimize the range in which detector 6 cannot detect any obstacle, and it is possible to improve the obstacle detection capability in the same manner as in the embodiment described above.

In addition, any of the embodiment described above is only illustration of a specific example for implementing the technique according to the present disclosure, and the technical scope of the technique according to the present disclosure shall not be construed limitedly thereby. That is, the technique according to the present disclosure can be implemented in various forms without departing from the main features thereof.

The disclosure of Japanese Patent Application No. 2023-080405, filed on May 15, 2023, including the specification, drawings and abstract, is incorporated herein by reference in its entirety.

### INDUSTRIAL APPLICABILITY

The technique in the present disclosure can be widely utilized for robots.

1. A robot, comprising:
a main body that includes a base and a top plate; and
a cart that is coupleable to the main body, wherein
the main body includes a detector in a space provided between the base and the top plate, the detector detecting an object that exists around the robot, and
a body-side support that couples the base to the top plate is included in a detection range of the detector.

2. The robot according to claim 1, wherein
the detector is located below the cart in a coupling state between the main body and the cart.

3. The robot according to claim 1, wherein
on a scan surface of the detector when the main body and the cart are coupled to each other, the body-side support, the detector, and a cart-side structure of the cart are arranged in series.

4. The robot according to claim 3, wherein
the cart-side structure is a support that supports a storer, the storer storing a thing.

5. The robot according to claim 1, wherein:
on a scan surface of the detector, the cart includes no structure behind a rear end portion of a side surface of the cart, and
on the scan surface of the detector when the main body and the cart are coupled to each other, the body-side support, the detector, and the rear end portion of the side surface of the cart are arranged in series.
